(19) United States
(12) Patent Application Publication
(10) Pub. No.: US 2025/0336235 A1
(43) Pub. Date: Oct. 30, 2025

(54) METHOD OF APPLYING ARTIFICIAL INTELLIGENCE TO DETECT GESTURES, ELECTRONIC DEVICE AND TERMINAL DEVICE CONNECTED THERETO, AND NON-TRANSITORY COMPUTER-READABLE STORAGE MEDIUM

(71) Applicant: COMPAL ELECTRONICS, INC., Taipei (TW)

(72) Inventors: CHUAN-SUNG CHANG, Taipei (TW); PIN-YU CHOU, Taipei (TW); YUEH-HUA LEE, Taipei (TW); CHING-JUI HSIAO, Taipei (TW)

(73) Assignee: COMPAL ELECTRONICS, INC., Taipei (TW)

(21) Appl. No.: 19/185,293

(22) Filed: Apr. 22, 2025

Related U.S. Application Data
(60) Provisional application No. 63/639,707, filed on Apr. 29, 2024.

(51) Int. Cl. G06V 40/20

(52) U.S. Cl. CPC G06V 40/20

(57) ABSTRACT

A method of applying artificial intelligence to detect gestures. The method includes: taking a photograph to obtain a real-time image output; performing artificial intelligence recognition on the real-time image output to obtain a frame of an object to be tested and a frame of a user to be tested; determining whether the frame of the user to be tested is in a position stable state and whether the frame of the object to be tested is in a stable presence state; when the judgement results are yes, recognizing by the artificial intelligence that the user to be tested holds the object to be tested, and recognizing by the artificial intelligence the real-time image output and detecting a movement of the object to be tested, so as to generate a movement change to trigger and generate an operation instruction; performing a corresponding media processing operation according to the operation instruction.

### CROSS-REFERENCE TO RELATED APPLICATION

This non-provisional application claims priority under 35 U.S.C. § 119 (e) on US provisional Patent Application No. 63/639,707 filed on Apr. 29, 2024, the entire contents of which are hereby incorporated by reference.

### BACKGROUND OF THE INVENTION

### 1. Field of the Invention

The present disclosure relates to a detection technique, and in particular to a method of applying artificial intelligence to detect gestures, an electronic device and a terminal device connected thereto, and a non-transitory computer-readable storage medium.

### 2. Description of the Related Art

Current electronic devices commercially available for detecting gesture interactions between a user (for example, an infant) and an interaction object (for example, a puppet) achieve accurate detection and interaction with the interaction object usually by means of additional electronic sensors or more additional electronic accessories on the interaction object.

However, the means above for achieving accurate detection and interaction with the interaction object result in two problems. First of all, in terms of product development, any additional electronic sensors increase development and research costs of the electronic device and complexities of the product, leading to more complications in maintaining product stability. Secondly, as infants often bite and chew objects that they hold, metal of additional electronic accessories on the interaction object and related elements are susceptible to be swallowed by infants in the course of biting and chewing, causing life hazards of infants in a way that the interaction object is unsafe for infants to play with.

Therefore, it is an object of the present disclosure to provide a solution for solving the above issues of the prior art.

### BRIEF SUMMARY OF THE INVENTION

Therefore, it is an object of the present disclosure to provide a method of applying artificial intelligence to detect gestures, an electronic device and a terminal device connected thereto, and a non-transitory computer-readable storage medium, so as to overcome the drawbacks of the prior art.

To achieve the object above, the present disclosure provides a method of applying artificial intelligence to detect gestures and performed by an electronic device reading multiple program codes. The method includes steps of: (A) taking a photograph of a region to be detected to obtain a real-time image output at least including an image of an object to be tested corresponding to an object to be tested and an image of a user to be tested corresponding to a user to be tested; (B) performing artificial intelligence recognition on the real-time image output to obtain a frame of the object to be tested that covers an image of the object to be tested and a frame of the user to be tested that covers an image of the user to be tested; (C) determining whether the frame of the user to be tested is in a position stable state and whether the frame of the object to be tested is in a stable presence state; (D) when the judgement results of step (C) are yes, recognizing by the artificial intelligence that the user to be tested is holding the object to be tested, and recognizing by the artificial intelligence the real-time image output and detecting a movement of the object to be tested to generate a movement change to trigger and generate an operation instruction corresponding to the movement change; and (E) performing a corresponding media processing operation according to the operation instruction, the media processing operation selected from an audio information processing and/or an image information processing.

In some embodiments, the method further includes, before step (A), a step of: (F) determining whether the electronic device meets a predetermined interaction condition, and performing step (A) when the judgement result is yes.

In some embodiments of the method, in step (F), when the electronic device receives a predetermined interaction establishment instruction, or receives an activation instruction for activating gesture detection, it is considered that the predetermined interaction condition is met, wherein the activation instruction is generated from receiving an input operation from the user to be tested.

In some embodiments of the method, when the real-time image output includes multiple object images and the image of the user to be tested, step (B) includes sub-steps of: (B1) performing the artificial intelligence recognition on the real-time image output to obtain multiple object frames that respectively cover the object images and the frame of the user to be tested; (B2) determining whether the object frames contain an object frame having an area smaller than an area of the frame of the user to be tested; (B3) when the judgement result of sub-step (B2) is yes, using each object frame of the object frames that has an area smaller than the area of the frame of the user to be tested as a target object frame; and (B4) using the target object frame having a largest overlapping degree with the frame of the user to be tested as the frame of the object to be tested.

In some embodiments of the method, when the real-time image output includes the image of the object to be tested and multiple user images, step (B) includes sub-steps of: (B1) performing the artificial intelligence recognition on the real-time image output to obtain the frame of the object to be tested and multiple user frames that respectively cover the multiple user images; (B2) determining whether the user frames contain a user frame having an area greater than an area of the frame of the object to be tested; (B3) when the judgement result of sub-step (B2) is yes, using each user frame of the user frames that has an area greater than the area of the frame of the object to be tested as a target user frame; and (B4) using the target user frame having a largest overlapping degree with the frame of the object to be tested as the frame of the user to be tested.

In some embodiments of the method, in step (C), within a predetermined detection time, when a presence time of an accumulated presence of the frame of the user to be tested is greater than or equal to a first predetermined time, a change in the area of the frame of the user to be tested is smaller than a predetermined area change value, and a change in a coordinate position of the frame of the user to be tested is smaller than a predetermined position change value, the frame of the user to be tested is in the position stable state; when a presence time of an accumulated presence of the frame of the object to be tested is greater than or equal to a second predetermined time, the area of the frame of the object to be tested at least partially overlaps the area of the frame of the user to be tested, and an accumulated overlapping time of the area at least partially overlapping is greater than or equal to a third predetermined time, the frame of the object to be tested is in the stable presence state.

In some embodiments of the method, in step (D), the detecting of the movement of the object to be tested detects a movement trajectory of a center point of the frame of the object to be tested, and includes detecting a relative change in an area size of the frame of the object to be tested and using the movement trajectory or the area change in the frame of the object to be tested as the movement change.

In some embodiments of the method, the electronic device includes a predetermined operation function database, which stores multiple predetermined movement changes and multiple respective corresponding predetermined operation instructions thereof. Step (D) further includes sub-steps of: (D1) determining, according to the real-time image output, whether the center point of the frame of the object to be tested is moved outside an initial positioning frame, wherein an area of the initial positioning frame is smaller than the area of the frame of the object to be tested and a center point of the initial positioning frame is same as the center point of the frame of the object to be tested that has not yet moved; (D2) when the judgement result of sub-step (D1) is yes, determining, according to the real-time image output, whether the center point of the frame of the object to be tested that has been moved is moved back inside the initial positioning frame within a predetermined movement time; (D3) when the judgement result of sub-step (D2) is yes, forming, according to a position of the center point of the initial positioning frame, and a position of the center point of each of the frame of the object to be tested that has been moved when the frame of the object to be tested is moved outside the initial positioning frame and moved back inside the initial positioning frame, a movement trajectory as the movement change; and (D4) comparing the movement change with the multiple predetermined movement changes in the predetermined operation function database to obtain the corresponding predetermined operation instruction as the operation instruction.

In some embodiments of the method, step (D) further includes a sub-step of: (D5) when the judgment result of sub-step (D2) is negative, generating a warning instruction indicating a gesture detection error or a detection failure, and playing a warning response according to the warning instruction, such that the object to be tested is again moved when the user to be tested hears the warning response.

In some embodiments of the method, the operation instruction instructs the electronic device to activate playing music, play a next music track or play a previous music track, stop playing music, or pause playing music.

The present disclosure further provides a non-transitory computer-readable storage medium storing multiple program codes, wherein an electronic device, after reading the program codes, is enabled to perform the method above.

The present disclosure further provides an electronic device applying artificial intelligence to detect gestures. The electronic device includes: a camera unit, for taking a photograph of a region to be detected to obtain a real-time image output, which at least includes an image of an object to be tested corresponding to an object to be tested and an image of a user to be tested corresponding to a user to be tested; a storage unit, storing multiple program codes; a smart processing unit, electrically connected to the camera unit to receive the real-time image output, and electrically connected to the storage unit to read the program codes and perform step (B), step (C) and step (D) of the method above; and a playback unit, electrically connected to the smart processing unit to receive the operation instruction, and performing a corresponding media processing operation according to the operation instruction, wherein the media processing operation is selected from an audio information processing and/or an image information processing.

In some embodiments of the electronic device, when the real-time image output includes multiple object images and the image of the user to be tested, the smart processing unit performs the artificial intelligence recognition on the real-time image output to obtain multiple object frames that respectively cover the object images, and the frame of the user to be tested; the smart processing unit determines whether the object frames contain an object frame having an area smaller than an area of the frame of the user to be tested, and when the judgement result is yes, uses each object frame of the object frames that has an area smaller than the area of the frame of the user to be tested as a target object frame; and the smart processing unit uses the target object frame having a largest overlapping degree with the frame of the user to be tested as the frame of the object to be tested.

In some embodiments of the electronic device, when the real-time image output includes the image of the object to be tested and multiple user images, the smart processing unit performs the artificial intelligence recognition on the real-time image output to obtain the frame of the object to be tested and multiple user frames that respectively cover the multiple user images; the smart processing unit determines whether the multiple user frames contain a user frame having an area greater than an area of the frame of the object to be tested, and when the judgement result is yes, uses each user frame of the user frames that has an area greater than the area of the frame of the object to be tested as a target user frame; and the smart processing unit uses the target user frame having a largest overlapping degree with the frame of the object to be tested as the frame of the user to be tested.

In some embodiments of the electronic device, within a predetermined detection time, when a presence time of an accumulated presence of the frame of the user to be tested is greater than or equal to a first predetermined time, a change in the area of the frame of the user to be tested is smaller than a predetermined area change value, and a change in a coordinate position of the frame of the user to be tested is smaller than a predetermined position change value, the frame of the user to be tested is in the position stable state; when a presence time of an accumulated presence of the frame of the object to be tested is greater than or equal to a second predetermined time, the area of the frame of the object to be tested at least partially overlaps the area of the frame of the user to be tested, and an accumulated overlapping time of the area at least partially overlapping is greater than or equal to a third predetermined time, the frame of the object to be tested is in the stable presence state.

In some embodiments, the electronic device further includes a predetermined operation function database, which stores multiple predetermined movement changes and multiple respective corresponding predetermined operation instructions thereof. Wherein, the smart processing unit determines, according to the real-time image output, whether a center point of the frame of the object to be tested is moved outside an initial positioning frame; when the judgement result is yes, the smart processing unit determines, according to the real-time image output, whether the center point of the frame of the object to be tested that has been moved is moved back inside the initial positioning frame within a predetermined movement time; when the judgement result is yes, the smart processing unit forms, according to a position of the center point of the initial positioning frame, and a position of the center point of each of the frame of the object to be tested that has been moved when the frame of the object to be tested is moved outside the initial positioning frame and moved back inside the initial positioning frame, a movement trajectory as the movement change, and compares the movement change with the predetermined movement changes in the predetermined operation function database to obtain the corresponding predetermined operation instruction as the operation instruction, wherein an area of the initial positioning frame is smaller than the area of the frame of the object to be tested and the center point of the initial positioning frame is same as the center point of the frame of the object to be tested that has not yet moved.

The present disclosure further provides a terminal device. The terminal device is communicatively connected to the electronic device above and mounted with an application, and becomes communicatively connected to the electronic device by executing the application. The terminal device provides a user interface while executing the application, and a user can set the predetermined operation function database and/or perform the media processing operation via the user interface.

Accordingly, the present disclosure provides the following effects. By performing the method by the electronic device by means of reading the program codes above, it is can determined whether a user indeed has an intention of moving the object to be tested to prevent misjudgment of the smart processing unit and further maintain the accuracy of gesture detection, thereby providing accurate recognition of a movement change of the object to be tested to activate the playback unit to perform a specific media processing operation, hence achieving the interaction between the user to be tested and the object to be tested. Thus, the present disclosure can dispense with additional electronic sensors in an electronic device for accurate detection and interactions with an interaction object or providing electronic accessories on the object to be tested as those in the prior art, the present disclosure is further capable of saving development and research costs and reducing product complexities of an electronic device to promote and maintain product stability, as well as preventing issues of life hazards of infants caused by the infants biting and chewing the object to be tested.

### BRIEF DESCRIPTION OF THE DRAWINGS

FIG. 1 is a block diagram of an electronic device applying artificial intelligence to detect gestures and a terminal device according to an embodiment of the present disclosure.

FIG. 2 is a schematic diagram of the electronic device and the terminal device according to the embodiment communicatively connected to each other by the Internet to perform a setting operation or a media processing operation.

FIG. 3 is a flowchart of a method of applying artificial intelligence to detect gestures performed by the electronic device according to the embodiment of the present disclosure.

FIG. 4A is a flowchart of obtaining a frame of an object to be tested and a frame of a user to be tested by using the method according to a first implementation form.

FIG. 4B is a schematic diagram of a real-time image output, the frame of the object to be tested and the frame of the user to be tested according to the first implementation form.

FIG. 5A is a flowchart of obtaining a frame of an object to be tested and a frame of a user to be tested by using the method according to a second implementation form.

FIG. 5B is a schematic diagram of a real-time image output, the frame of the object to be tested and the frame of the user to be tested according to the second implementation form.

FIG. 6A is a flowchart of obtaining an operation instruction by using the method.

FIG. 6B is a schematic diagram of a movement change of an object to be tested according to the embodiment.

FIG. 6C is a schematic diagram of a movement change of an object to be tested according to the embodiment.

FIG. 7A is a schematic diagram of moving a puppet to implement a playback control operation according to the embodiment.

FIG. 7B is a schematic diagram of moving the puppet to implement a playback control operation according to the embodiment.

FIG. 7C is a schematic diagram of moving the puppet to implement a playback control operation according to the embodiment.

FIG. 7D is a schematic diagram of moving a puppet to implement a playback control operation according to the embodiment.

### DETAILED DESCRIPTION OF THE INVENTION

To facilitate understanding of the object, characteristics and effects of the present disclosure, embodiments together with the attached drawings for the detailed description of the present disclosure are provided below.

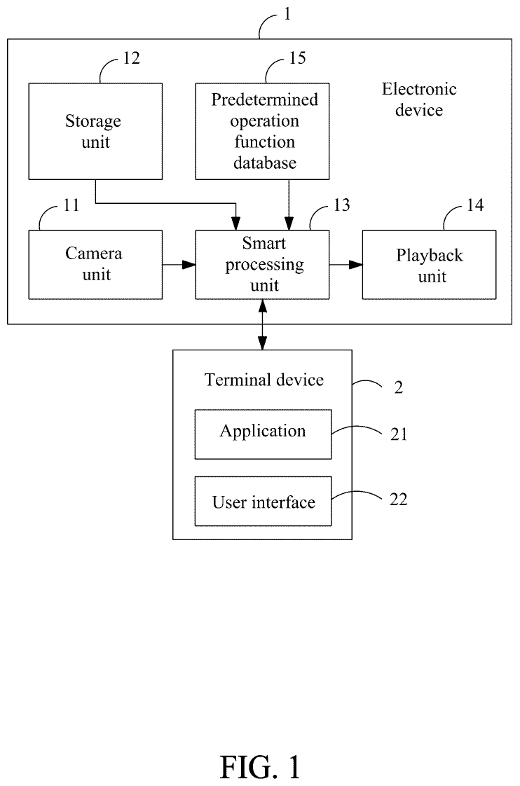

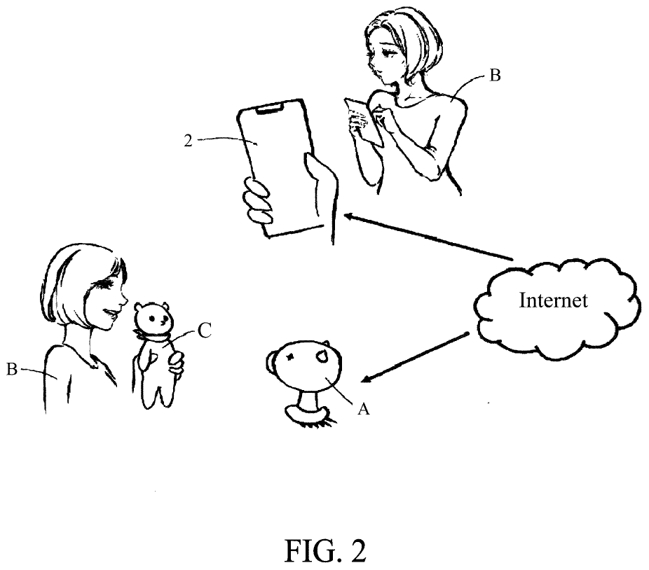

Referring to FIG. 1 and FIG. 2, an electronic device 1 applying artificial intelligence to detect gesture and a terminal device 2 communicatively connected to the electronic device 1 according to an embodiment of the present disclosure are described below. The electronic device 1 includes a camera unit 11, a storage unit 12, a smart processing unit 13, a playback unit 14 and a predetermined operation function database 15. In this embodiment, the storage unit 12 stores multiple program codes. The predetermined operation function database 15 stores multiple predetermined movement changes and multiple respective corresponding predetermined operation instructions. The multiple predetermined movement changes are, for example, front and back, up and down, left and right, and/or circling movements, and the predetermined operation instructions are, for example, playing, pausing, stopping, fast forwarding to a next track and/or rewinding to a previous track; however, the present disclosure is not limited to the examples above.

In this embodiment, the electronic device 1 is a physical host, and at this point in time, the storage unit 12, the smart processing unit 13 and the predetermined operation function database 15 are provided at a same apparatus body as the camera unit 11; however, the present disclosure is not limited to the example above. For example, in one embodiment, the electronic device 1 may be a cloud host, and the storage unit 12, the smart processing unit 13 and the predetermined operation function database 15 included therein are located at a remote end.

The terminal device 2 is mounted with an application 21, and is communicatively connected to the electronic device 1 by executing the application 21. A user interface 22 is provided while the terminal device 2 executes the application 21, and a user can, via the user interface 22, set the predetermined operation function database 15, and/or perform a media processing operation carried out by the payback unit 14. The terminal device 2 can be a portable mobile communication device, for example, a smartphone, or a device such as a table computer or a laptop computer communicatively connectable to the electronic device 1 in a wired or wireless manner via the Internet.

The camera unit 11 is for taking photographs consecutively on a region to be detected to sequentially obtain a real-time image output. Each of the real-time image output at least includes an image of an object to be tested corresponding to an object to be tested, and an image of a user to be tested corresponding to a user to be tested. In one embodiment, the camera unit 11 is a camera for monitoring, for example, an infant, and the real-time image output is an image taken in real time of a region to be detected (within a visual range of the camera unit 11) where the infant is located. In one embodiment, the camera unit 11 is mounted on a support (not shown) and is located at a certain height, such that a range of the real-time image output can at least cover the object to be tested and the user to be tested, and can thus be used for detecting and recognizing a gesture of the user to be tested and an interaction relation thereof with the object to be tested.

In this embodiment, the electronic device 1 is, for example, the camera A shown in FIG. 2, and the user is, for example, the adult B shown in FIG. 2. Further, the object to be tested is, for example, the puppet C shown in FIG. 2; however, the present disclosure is not limited to the example above. For example, any toys, teaching props or objects loved by the infant can be included. As shown in FIG. 2, the camera A performs image artificial intelligence recognition on the adult B holding the puppet C. Moreover, with a communication connection with the terminal device 2 via the Internet, the adult B can perform related control at a remote end via the terminal device 2, for example, setting the predetermined operation function database 15.

The smart processing unit 13 is electrically connected to the camera unit 11, the storage unit 12 and the predetermined operation function database 15, receives the real-time image output from the camera unit 11, and reads the program codes stored in the storage unit 12 to perform a part of the method of applying artificial intelligence to detect gestures of the present disclosure, so as to trigger and generate an operation instruction.

The playback unit 14 is electrically connected to the smart processing unit 13 to receive the operation instruction, and performs a corresponding media processing operation according to the operation instruction, wherein the media processing operation is selected from an audio information processing and/or an image information processing. In one embodiment, the media processing operation is, for example, selected from the audio information processing, and the playback unit 14 is, for example, by the audio information processing performed according to the operation instruction, an audio player which can perform behaviors such as setting (music stories or music) playing, pausing playing, playing a previous story (music track) or a next story (music track), adjusting the volume, and stopping playing according to a movement trajectory of the puppet C; or activating or stopping audio recording of a voice of the user to be tested, such as recording the voice of infants or story discussions and interactions between parents and infants. In other embodiments, the media processing operation is, for example, selected from the image information processing, and the playback unit 14 is, for example, a video player which can, by the image information processing performed according to the operation instruction, take photographs, record videos, or pause or activate taking photographs/recording videos according to the movement trajectory of the puppet C.

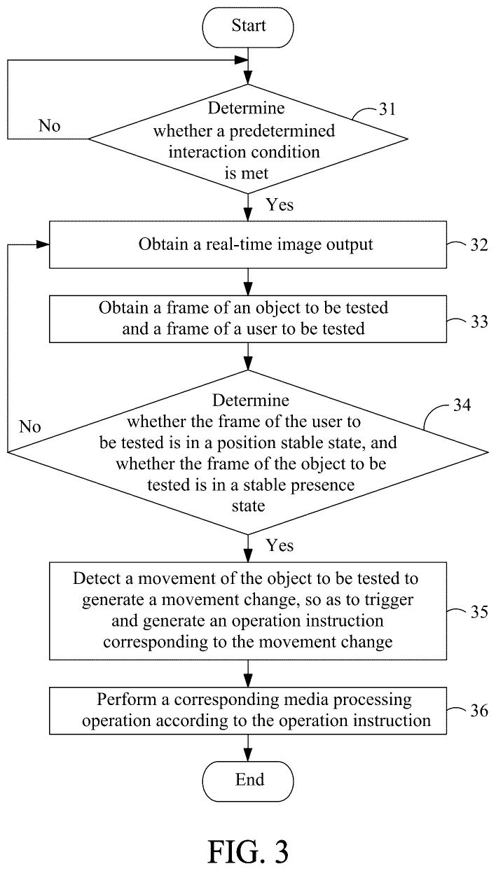

Further refer to FIG. 3 showing a flowchart of a method of applying artificial intelligence to detect gestures performed by the electronic device 1 by means of reading the program codes according to the embodiment of the present disclosure. The method of applying artificial intelligence to detect gestures of the present disclosure includes steps 31 to 36 below.

In step 31, it is determined whether the electronic device 1 meets a predetermined interaction condition. Step 32 is performed when the judgement result is yes, or step 31 is iterated when the judgement result is negative.

In this embodiment, when the electronic device 1 receives a predetermined interaction establishment instruction, or receives an activation instruction for activating gesture detection, it is considered that the predetermined interaction condition is met, that is, the system is set as an interaction enabled mode, wherein the activation instruction is generated from receiving an input operation from the user to be tested. It should be noted that, the predetermined interaction establishment instruction is, for example, obtained when the user to be tested has purchased the object to be tested and has paid to subscribe to a gesture detection function. The input operation is, for example, an operation corresponding to the user to be tested activating a gesture detection function in the application 21. In other embodiments, the method of applying artificial intelligence to detect gestures of the present disclosure can omit step 31 and directly proceed to step 32.

In step 32, the camera unit 11 takes a photograph of the region to be detected so as to obtain the real-time image output.

In step 33, the smart processing unit 13 performs artificial intelligence recognition (that is, image AI recognition) on the real-time image output to obtain a frame of the object to be tested that covers the image of the object to be tested, and a frame of the user to be tested that covers the image of the user to be tested.

In this embodiment, the frame of the object to be tested is defined as a frame of a location and a real-time area of the object to be tested, and the frame of the user to be tested is defined as a frame of a location and a real-time area of the user to be tested. The smart processing unit 13 performs the image AI recognition (for example, performing image object detection by using deep learning) on the real-time image output to obtain a confidence score of each object or each user, so as to determine the object to be tested and the user to be tested according to the confidence score.

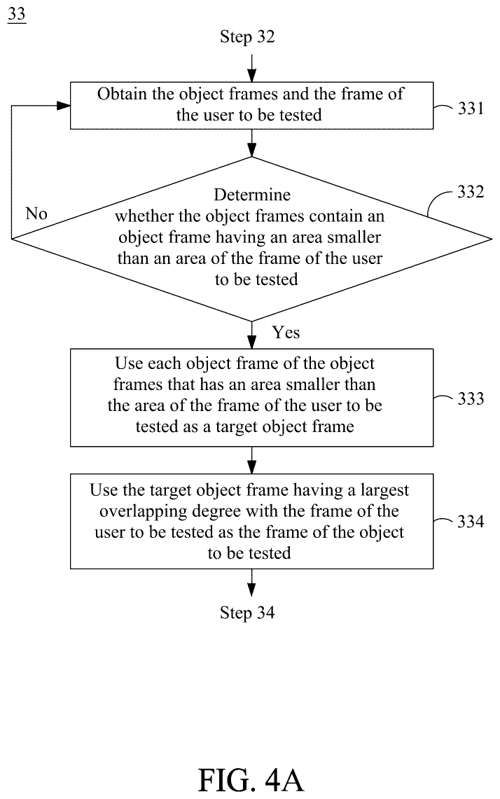

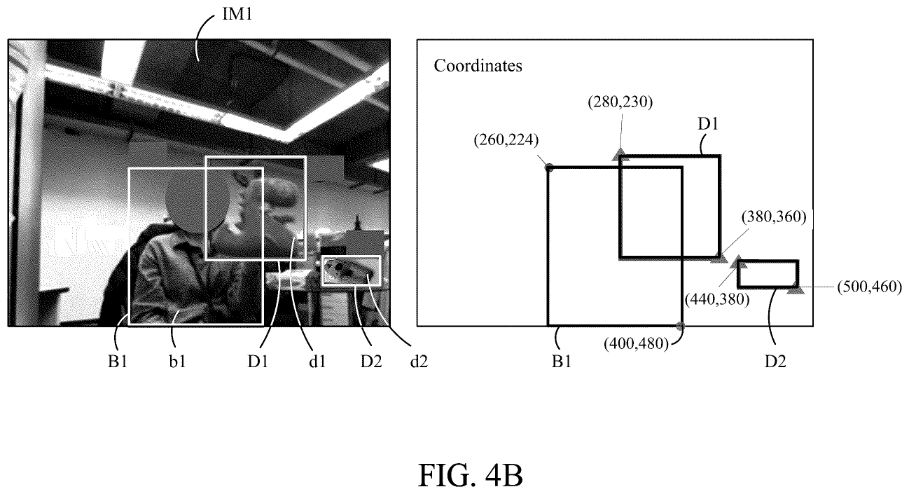

It should be noted that, in this embodiment, step 33 may be implemented in two implementation forms. Further refer to FIG. 4A and FIG. 4B for the first implementation form of step 33. When the real-time image output (such as the real-time image output IM1 shown in FIG. 4B) includes multiple object images d1 and d2 and an image of the user to be tested (such as the image bl of the user to be tested shown in FIG. 4B), the smart processing unit 13 obtains the frame of the user to be tested (such as the frame B1 of the user to be tested shown in FIG. 4B) according to a frame that covers the image bl of the user to be tested, and determines, from multiple object frames D1 and D2 that respectively cover the object images d1 and d2, an object frame having a largest overlapping degree with the frame B1 of the user to be tested and an object therein, as the frame of the object to be tested and the object to be tested. More specifically, step 33 includes sub-steps 331 to 334 below.

In sub-step 331, the smart processing unit 13 performs the artificial intelligence recognition on the real-time image output IM1 to obtain the object frames D1 and D2 and the frame B1 of the user to be tested. In this embodiment, the real-time image output IM1 is a color image in 640×480 pixels; however, the present disclosure is not limited to the example above.

In sub-step 332, the smart processing unit 13 determines whether the object frames D1 and D2 contain an object frame having an area smaller than an area of the frame B1 of the user to be tested. Sub-step 333 is performed when the judgement result is yes, or sub-step 331 is iterated when the judgement result is negative.

In this embodiment, after performing the artificial intelligence recognition, the smart processing unit 13 can obtain coordinate positions of two corresponding frame corners of each of the object frames D1 and D2 and the frame B1 of the user to be tested, and calculate the area of each of the object frames D1 and D2 and the frame B1 of the user to be tested according to the coordinate positions, so as to determine whether the object frames D1 and D2 contain an object frame having an area smaller than the area of the frame B1 of the user to be tested. For example, in FIG. 4B, the area of the frame B1 of the user to be tested is (400−260)×(480−224)=35840; the area of the object frame D1 is (380−280)×(360−230)=13000; the area of the object frame D2 is (500−440)×(460−380)=4800. Thus, the smart processing unit 13 determines that the areas of both of the object frames D1 and D2 are smaller than the area of the frame B1 of the user to be tested; that is to say, the object frames D1 and D2 contain object frames having areas smaller than the area of the frame B1 of the user to be tested. That is, the judgement result of sub-step 332 is yes, and sub-step 333 is thus performed.

In sub-step 333, the smart processing unit 13 uses each object frame of the object frames D1 and D2 that has an area smaller than the area of the frame B1 of the user to be tested as a target object frame. In this embodiment, because the areas of both of the object frames D1 and D2 are smaller than the area of the frame B1 of the user to be tested, each of the object frames D1 and D2 is the target object frame.

In sub-step 334, the smart processing unit 13 uses the target object frame having a largest overlapping degree with the frame B1 of the user to be tested as the frame of the object to be tested.

More specifically, in this embodiment, an equation of the overlapping degree ΔAx of the target object frame (that is, the object frames D1 and D2) with the frame B1 of the user to be tested is:

$$Δ A x = IOU / A Dx ;$$

where x is a variable, and x=1, 2 in this embodiment. The parameter ΔA1 is the overlapping degree of the object frame D1 with the frame B1 of the user to be tested, and the parameter ΔA2 is the overlapping degree of the object frame D2 with the frame B1 of the user to be tested. The parameter ΔA Dx is the area of the target object frame, that is, AD1 is the area of the object frame D1 and AD2 is the area of the object frame D2. IOU (intersection over union) is defined as a union of the area AB1 of the frame B1 of the user to be tested and the area A Dx of the target object frame (that is, the object frames D1 and D2); that is, IOU=AB1∩ADx. The ratio of the overlapping degree ΔAx ranges between 0 and 1, where 1 is the maximum value and 0 is the minimum value. For example, in FIG. 4B,

$$Δ A 1 = A B 1 ⋂ D 1 / A D 1 = 8600 / 13000 = 66 \% ;$$

$$Δ A 2 = A B 1 ⋂ A D 2 / A D 2 = 0 / 4800 = 0 \% .$$

Since the overlapping degree ΔA1 is greater than the overlapping degree ΔA2, ΔA1 has the largest (larger) overlapping degree, and thus the object frame D1 is used as the frame of the object to be tested.

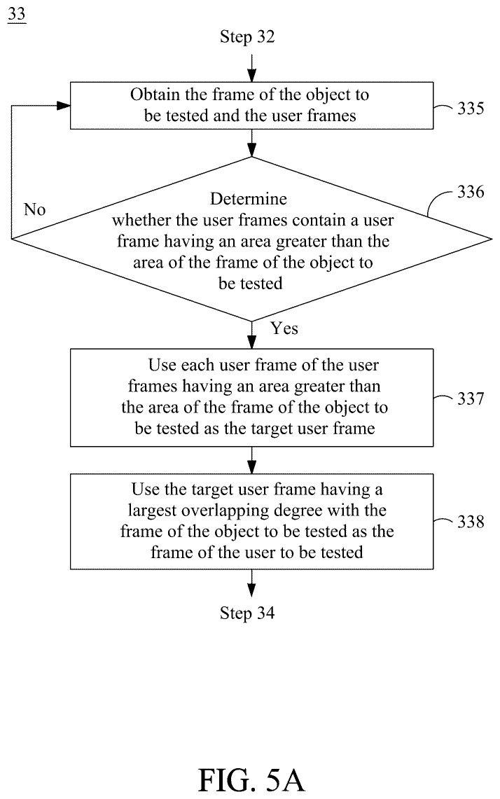

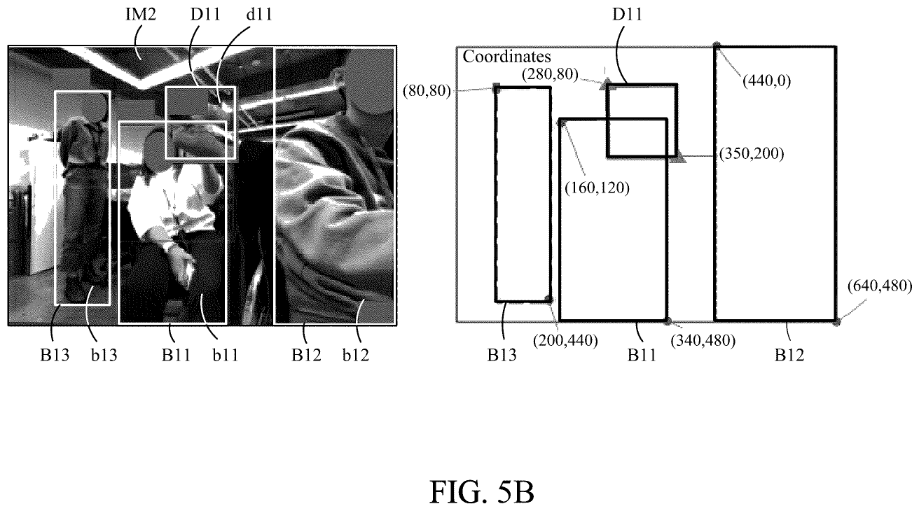

Further refer to FIG. 5A and FIG. 5B for the second implementation form of step 33. When the real-time image output (such as the real-time image output IM2 shown in FIG. 5B) includes the image of the object to be tested (such as the image d11 of the object to be tested shown in FIG. 5B) and multiple user images b11, b12 and b13, the smart processing unit 13 obtains the frame of the object to be tested (as the frame D11 of the object to be tested shown in FIG. 5B) according to a frame that covers the image d11 of the object be tested, and determines, from multiple user frames B11, B12 and B13 that respectively cover the user images b11, b12 and b13, a user frame having a largest overlapping degree with the frame D11 of the object to be tested and a user therein, as the frame of the user to be tested and the image of the user to be tested. More specifically, step 33 includes sub-steps 335 to 338 below.

In sub-step 335, the smart processing unit 13 performs the artificial intelligence recognition on the real-time image output IM2 to obtain the frame D11 of the object to be tested and the user frames B11, B12 and B13.

In sub-step 336, the smart processing unit 13 determines whether the user frames B11, B12 and B13 contain a user frame having an area greater than an area of the frame D11 of the object to be tested. Sub-step 337 is performed when the judgement result is yes, or sub-step 335 is iterated when the judgement result is negative.

In this embodiment, after performing the artificial intelligence recognition, the smart processing unit 13 can obtain coordinate positions of two corresponding frame corners of each of the user frames B11, B12 and B13 and the frame D11 of the object to be tested, and calculate the area of each of the user frames B11, B12 and B13 and the frame D11 of the object to be tested according to the coordinate positions, so as to determine whether the user frames B11, B12 and B13 contain a user frame having an area greater than the area of the frame D11 of the object to be tested. For example, in FIG. 5B, the area of the frame D11 of the object to be tested is (350−280)×(200−80)=8400; the area of the user frame B11 is (340−160)×(480−120)=64800; the area of the user frame B12 is (640−340)×(480−40)=96000; the area of the user frame B13 is (344−320)×(300−240)=43200. Thus, the smart processing unit 13 determines that the areas of all of the user frames B11, B12 and B13 are greater than the area of the frame D11 of the object to be tested; that is to say, the user frames B11, B12 and B13 contain user frames having areas greater than the area of the frame D11 of the object to be tested. Thus, the judgement result of sub-step 336 is yes, and sub-step 337 is thus performed.

In sub-step 337, the smart processing unit 13 uses each user frame of the user frames B11, B12 and B13 that has an area greater than the area of the frame D11 of the object to be tested as a target user frame. In this embodiment, because the areas of all of the user frames B11, B12 and B13 are greater than the area of the frame D11 of the object to be tested, each of the user frames B11, B12 and B13 is the target user frame.

In sub-step 338, the smart processing unit 13 uses the target user frame having a largest overlapping degree with the frame D11 of the object to be tested as the frame of the user to be tested.

More specifically, in this embodiment, an equation of the overlapping degree ΔA′x of the target user frame (that is, the user frames B11, B12 and B13) with the frame D11 of the object to be tested is:

$$Δ {A}^{′} x = A B x ⋂ A D 11 / A D 11 ,$$

where x is a variable, and x=11, 12, 13 in this embodiment. The parameter ΔA′11 is the overlapping degree of the user frame B11 with the frame D11 of the object to be tested, the parameter ΔA′12 is the overlapping degree of the user frame B12 with the frame D11 of the object to be tested, and the parameter ΔA′13 is the overlapping degree of the user frame B13 with the frame D11 of the object to be tested. The parameter ABx is the area of the target user frame, that is, A B11 is the area of the user frame B11, A B12 is the area of the user frame B12, and A B13 is the area of the user frame B13. For example, in FIG. 5B,

$$Δ {A}^{′} 11 = A B 11 ⋂ A D 11 / A D 11 = 6048 / 8400 = 72 \% ;$$

$$Δ {A}^{′} 12 = A B 12 ⋂ A D 11 / A D 11 = 0 / 8400 = 0 \% ;$$

$$and$$

$$Δ {A}^{′} 13 = A B 13 ⋂ A D 11 / A D 11 = 0 / 8400 = 0 \% .$$

Since the overlapping degree ΔA′11 is the largest one, the user frame B11 is used as the frame of the user to be tested.

Next, referring to FIG. 3, step 34 is performed after the frame of the object to be tested and the frame of the user to be tested are obtained in step 33.

In step 34, the smart processing unit 13 determines whether the frame of the user to be tested is in a position stable state, and determines whether the frame of the object to be tested is in a stable presence state. When the judgement result is yes (that is, the frame of the user to be tested is in the position stable state, and the frame of the object to be tested is in the stable presence state), step 35 is performed; when the judgement result is negative, step 32 is iterated. In this embodiment, the purpose of step 34 determining that the frame of the user to be tested is in the position stable state and the frame of the object to be tested is in the stable presence state is to determine whether the user to be tested indeed has an intention of moving the object to be tested, so as to prevent the smart processing unit 13 from misjudging a user intention to thereby provide subsequent functions of accurate recognition and controlling the playback unit 14 to activate a specific media processing operation.

In this embodiment, within a predetermined detection time (for example, within 3 seconds counting from the smart processing unit 13 detects the presence of the frame of the user to be tested), when a presence time of an accumulated presence (that is, the time of the accumulated actual presence within the 3 seconds) of the frame of the user to be tested is greater than or equal to a first predetermined time (for example, the first predetermined time is preset to be 2.5 seconds), a change in the area of the frame of the user to be tested is smaller than a predetermined area change value (for example, the change in the area of the frame of the user to be tested is within ±10% of its original area), and a change in the coordinate position of the frame of the user to be tested is smaller than a predetermined position change value, the frame of the user to be tested is considered to be in the position stable state; however, the present disclosure is not limited to the example above. In this embodiment, the change in the coordinate position of the frame of the user to be tested being smaller than the predetermined position change value is defined as that an X-axis shift and a Y-axis shift of the coordinate position of the frame of the user to be tested are respectively within 40% of the width and within 40% of the length of the frame of the user to be tested. For example, referring to FIG. 5B, the X-axis shift of the coordinate position (160, 120) of the frame of the user to be tested (that is, the user frame B11) is within 40% of the width of the frame of the user to be tested (that is, (340−160)×40%), and the Y-axis shift thereof is within 40% of the length of the frame of the user to be tested (that is, (480−120)×40%). Moreover, within a predetermined detection time (for example, within 3 seconds counting from the smart processing unit 13 detects the presence of the frame of the object to be tested), when a presence time of an accumulated presence of the frame of the object to be tested (that is, the time of the accumulated actual presence within the 3 seconds) is greater than or equal to a second predetermined time (for example, the second predetermined time is preset to be 1.8 seconds), the area of the frame of the object to be tested at least partially overlaps the area of the frame of the user to be tested (that is, an overlapping degree is greater than 0), and an accumulated overlapping time of the area at least partially overlapping is greater than or equal to a third predetermined time (for example, the third predetermined time is preset to be 2.5 seconds), it is considered that the frame of the object to be tested is in the stable presence state; however, the present disclosure is not limited to the example above.

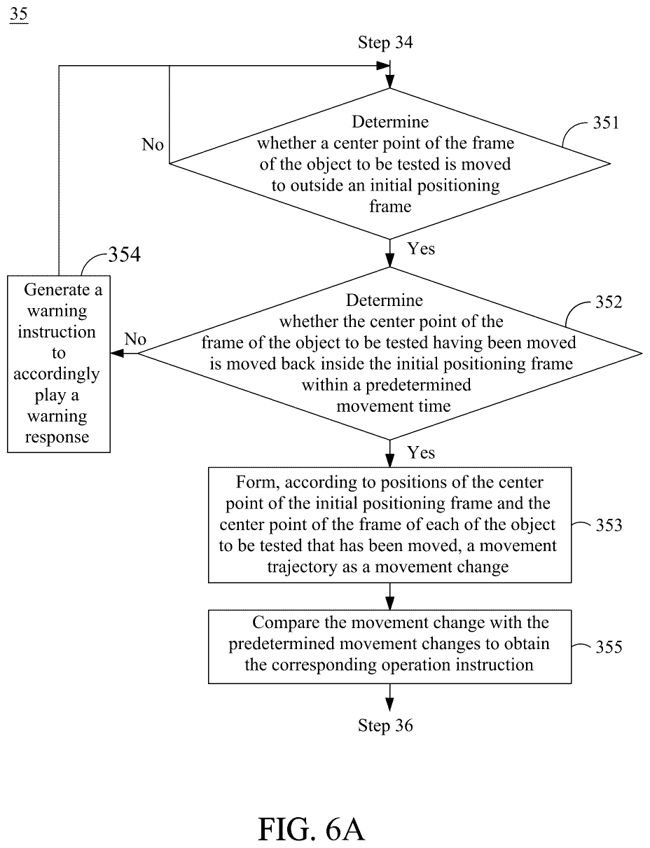

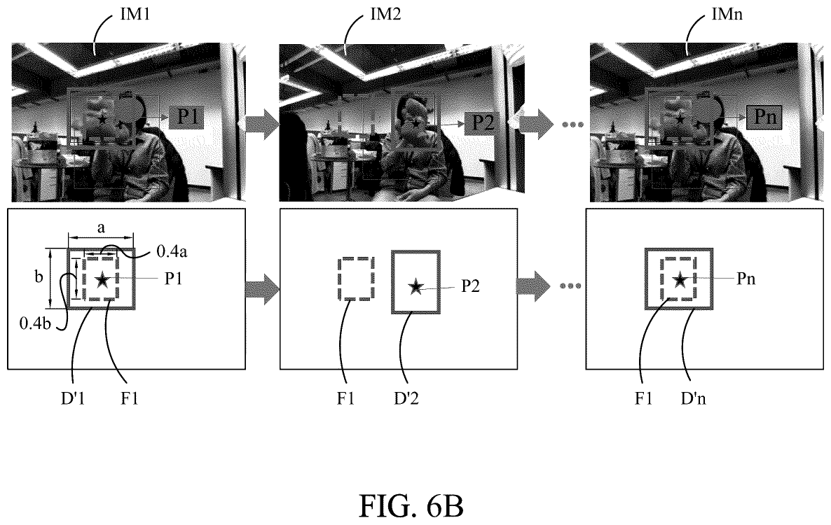

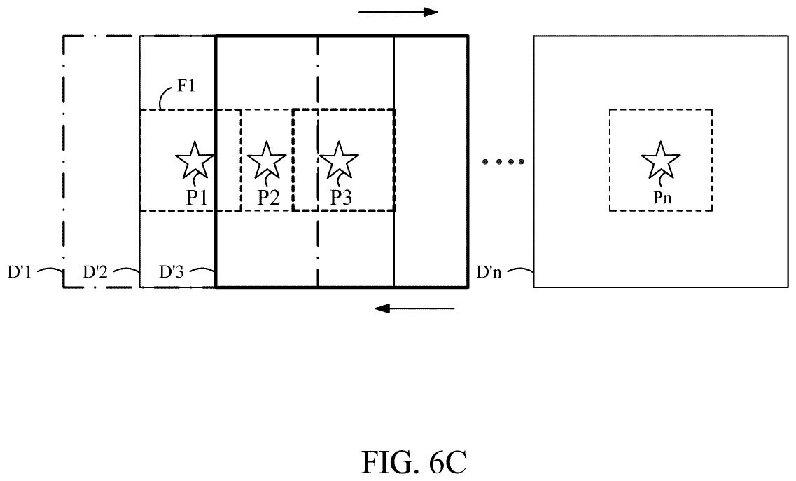

In step 35, the smart processing unit 13 recognizes by the artificial intelligence that the user to be tested holds the object to be tested, recognizes by the artificial intelligence the real-time image output subsequently sequentially appearing and detects a movement of the object to be tested, so as to generate a movement change and trigger and generate an operation instruction corresponding to the movement change. In this embodiment, the detecting of the movement of the object to be tested detects a movement trajectory of a center point of the frame of the object to be tested of each of the real-time image output (for example, a movement trajectory of the object to be tested that is moved up and down and/or left and right, and may be, for example but not limited to, a geometric pattern), and includes detecting a relative change in an area size of each of the frame of the object to be tested (for example, a relative change in an area size caused by the object to be tested that is moved front and back in the real-time image output), and using the movement trajectory or the area change in the frame of the object to be tested as the movement change; however, the present disclosure is not limited to the example above. Further refer to FIG. 6A and FIG. 6B. In this embodiment, step 35 includes sub-steps 351 to 355 below.

In sub-step 351, the smart processing unit 13 determines, according to the real-time image output (such as the real-time image outputs IM1 and IM2 sequentially appearing in FIG. 6B), whether a center point P2 of the frame of the object to be tested (such as the frame D′2 of the object to be tested shown in FIG. 6B) is moved outside an initial positioning frame F1. Sub-step 352 is performed when the judgement result is yes, or sub-step 351 is iterated when the judgement result is negative.

In this embodiment, the frame of the object to be tested that has not yet moved (such as the frame D′1 of the object to be tested shown in FIG. 6B) defines the initial positioning frame F1 by using its center point P1 as a center. An area of the initial positioning frame F1 is smaller than an area of the frame D′1 of the object to be tested, and the center point of the initial positioning frame F1 is the same as the center point P1 of the frame D′1 of the object to be tested. A length/width of the initial positioning frame F1 is m times a length/width of the frame D′1 of the object to be tested, where m=0.2 to 0.6, and m=0.4 in this embodiment; however, the present disclosure is not limited to the example above. As shown in FIG. 6B, in a coordinate position (X2, Y2) of the center point P2 of the frame D′2 of the object to be tested corresponding to the real-time image output IM2, if [X1−(0.2×a)]>X2 or [X1+(0.2×a)]<X2, and/or [Y1−(0.2×b)]>Y2 or [Y1+(0.2×b)]<Y2, it is determined that the position of the center point P2 of the frame D′2 of the object to be tested is moved outside the initial positioning frame F1. The parameters X1 and Y1 are respectively an X coordinate position and a Y coordinate position of the center point P1 of the frame D′1 of the object to be tested, and the parameters a and b are respectively a length in the X coordinate and a length in the Y coordinate of the boundary of the frame D′1 of the object to be tested.

In sub-step 352, the smart processing unit 13 determines, according to the real-time image output (as shown in FIG. 6B, the third real-time image output (which is a next real-time image output of the real-time image output IM2) to the real-time image output IMn), whether a center point Pn of the frame D′n of the object to be tested that has been moved is moved back inside the initial positioning frame F1 within a predetermined movement time (for example but not limited to, 5 seconds). Sub-step 353 is performed when the judgement result is yes, or sub-step 354 is performed when the judgement result is negative. In this embodiment, in the real-time image output IMn, the frame D′n of the object to be tested and the center point Pn, n is a variable and is a positive integer not less than 3.

More specifically, in this embodiment, it is determined whether any center point of the coordinate positions of the center points P3 to Pn is moved back inside the range of the initial positioning frame F1 within the predetermined movement time, and once it is determined that any center point is moved back inside the initial positioning frame F1, the determining stops. In this embodiment, in the coordinate positions (Xn, Yn) of the center point Pn of the frame D′n of the object to be tested corresponding to the real-time image output IMn, if [X1−(0.2×a)]<Xn<[X1+(0.2×a)] and [Y1−(0.2×b)]<Yn<[Y1+(0.2×b)], it is determined that the center point Pn of the frame D′n of the object to be tested is moved back inside the range of the initial positioning frame F1. The parameters X1 and Y1 are respectively an X coordinate position and a Y coordinate position of the center point P1 of the frame D′1 of the object to be tested, and the parameters a and b are respectively a length in the X coordinate and a length in the Y coordinate of the boundary of the frame D′1 of the object to be tested. For example, as shown in FIG. 6C, when the object to be tested is first moved to the right and then moved to the left and the position of the center point Pn is moved back inside the initial positioning frame F1, the judgement result of the smart processing unit 13 is yes, and sub-step 353 is performed.

In sub-step 353, the smart processing unit 13 forms, according to the position of the center point P1 of the initial positioning frame F1, and the position of the center point of each of the frames of the object to be tested that has been moved when the frames D′1 to D′n of the object to be tested are moved outside the initial positioning frame F1 and moved back inside the initial positioning frame F1, a movement trajectory as the movement change. In this embodiment, the center points P1 to Pn are connected to obtain the movement trajectory of the object to be tested; that is, the movement trajectory of the object to be tested shown in FIG. 6C indicates left and right movements.

In step sub-step 354, the smart processing unit 13 generates and transmits a warning instruction indicating a gesture detection error or a detection failure to the playback unit 14, such that the playback unit 14 plays a warning response according to the warning instruction, the object to be tested is again moved when the user to be tested hears the warning response, and the smart processing unit 13 iterates sub-step 351.

In sub-step 355, the smart processing unit 13 compares the movement change with the predetermined movement changes in the predetermined operation function database to obtain and output the corresponding predetermined operation instruction as the operation instruction to the playback unit 14. In this embodiment, the predetermined movement changes are front and back, up and down, left and right and/or circling movements, the corresponding predetermined operation instructions are respectively playing, pausing, stopping, fast forwarding to a next track and/or rewinding to a previous track, and the operation instruction is instructing the playback unit 14 to activate playing music, pause playing music, stop playing music, play a previous (next) music track; however, the present disclosure is not limited to the examples above. In other embodiments, the operation instruction may instruct the playback unit 14 to perform image playback.

In step 36, the playback unit 14 performs the corresponding media processing operation according to the operation instruction.

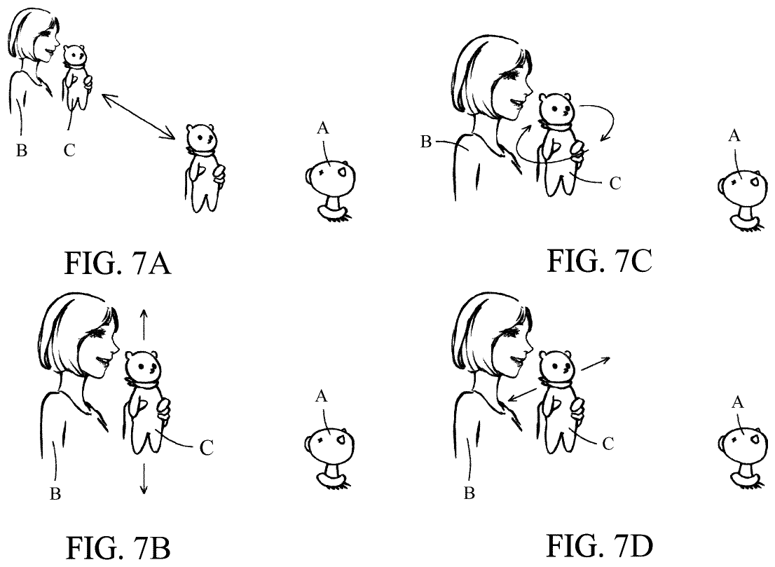

In this embodiment, when the playback unit 14 performs the media processing operation selected from the audio information processing to play audio, for example, a part of a music track or a story, if it is detected that the object to be tested moves according to a predetermined trajectory and generates the movement change, the smart processing unit 13 generates the operation instruction, and the playback unit 14 controls playback of an audio response according to the operation instruction. In one embodiment, as shown in FIG. 7A to FIG. 7D, playing, pausing playing, playback a previous track or a next track, and stopping playback can be set according to the movement trajectory of the puppet C; for example, when the movement of the puppet C captured by the camera unit 11 is “moving front and back”, the function of “play” is performed (as shown in FIG. 7A); when the movement of the puppet C captured by the camera unit 11 is “moving up and down”, the function of “pause playback” is performed (as shown in FIG. 7B); when the movement of the puppet C captured by the camera unit 11 is “moving in circles”, the function of “play a previous track (for example, corresponding to circling clockwise)” or “play a next track (for example, corresponding to circling counterclockwise)” (as shown in FIG. 7C); when the movement of the puppet C captured by the camera unit 11 is “moving left and right”, the function of “stop playback” is performed (as shown in FIG. 7D). The movement trajectory and the corresponding playback function described above may be modified by means of setting the predetermined operation function database 15 according to actual application requirements, thereby providing more simple and flexible applications for playback control.

The present disclosure further provides a non-transitory computer-readable storage medium storing multiple program codes above. The electronic device 1, after reading these program codes, is enabled to perform the method of applying artificial intelligence to detect gestures of the present disclosure shown in FIG. 3 according to the embodiment above.

In conclusion, in the present disclosure, the method of applying artificial intelligence to detect gestures is performed by the electronic device 1 by means of reading the program codes, the program codes can be stored in the non-transitory computer-readable storage medium, and the electronic device 1 is communicatively connected to the terminal device 2. By performing the method, the electronic device 1 can determine whether the user indeed has an intention of moving the object to be tested to prevent misjudgment of the smart processing unit 13 and further allowing the smart processing unit 13 to maintain the accuracy of gesture detection, thereby providing accurate recognition of the movement change of the object to be tested to activate the playback unit 14 to perform the specific media processing operation, hence achieving the interaction between the user to be tested and the object to be tested. Thus, the present disclosure can dispense with additional electronic sensors for accurate detection and interactions with an interaction object as those in the prior art, the present disclosure is capable of saving development and research costs and reducing product complexities of the electronic device 1 to promote and maintain product stability. Moreover, by performing the method, electronic accessories required for accurate detection and interactions with the object to be tested do not have to be provided on the object to be tested; that is, the object to be tested itself does not carry any electricity. Thus, issues of life hazards of infants caused by the infants biting and chewing the object to be tested can be prevented, hence ensuring maximized safety of infants while interacting with the object to be tested.

The description above provides merely preferred embodiments of the present disclosure, and is not to be construed as limitations to the scope of implementation of the present disclosure. All simple and equivalent variations and modifications made to the embodiments based on the claims and the description of the present disclosure are encompassed within the scope of the present disclosure.

While the present disclosure has been described by means of specific embodiments, numerous modifications and variations could be made thereto by those skilled in the art without departing from the scope and spirit of the present disclosure set forth in the claims.

What is claimed is:

1. A method of applying artificial intelligence to detect gestures, performed by an electronic device by means of reading a plurality of program codes, the method comprising steps of:
(A) taking a photograph of a region to be detected to obtain a real-time image output, the real-time image output at least comprising an image of an object to be tested corresponding to an object to be tested, and an image of a user to be tested corresponding to a user to be tested;
(B) performing artificial intelligence recognition on the real-time image output to obtain a frame of the object to be tested that covers the image of the object to be tested, and a frame of the user to be tested that covers the image of the user to be tested;
(C) determining whether the frame of the user to be tested is in a position stable state, and determining whether the frame of the object to be tested is in a stable presence state;
(D) when the judgement results of step (C) are yes, recognizing by the artificial intelligence that the user to be tested holds the object to be tested, and recognizing by the artificial intelligence the real-time image output and detecting a movement of the object to be tested, so as to generate a movement change and trigger and generate an operation instruction corresponding to the movement change; and
(E) performing a corresponding media processing operation according to the operation instruction, wherein the media processing operation is selected from an audio information processing and/or an image information processing.

2. The method according to claim 1, before step (A) further comprising a step of:
(F) determining whether the electronic device meets a predetermined interaction condition, and performing step (A) when the judgement result is yes.

3. The method according to claim 2, wherein in step (F), when the electronic device receives a predetermined interaction establishment instruction, or receives an activation instruction for activating gesture detection, it is considered that the predetermined interaction condition is met, wherein the activation instruction is generated from receiving an input operation from the user to be tested.

4. The method according to claim 1, wherein when the real-time image output comprises a plurality of object images and the image of the user to be tested, step (B) comprises sub-steps of:
(B1) performing the artificial intelligence recognition on the real-time image output to obtain a plurality of object frames that respectively cover the object images, and the frame of the user to be tested;
(B2) determining whether the object frames contain an object frame having an area smaller than an area of the frame of the user to be tested;
(B3) when the judgement result of sub-step (B2) is yes, using each object frame of the object frames that has an area smaller than the area of the frame of the user to be tested as a target object frame; and
(B4) using the target object frame having a largest overlapping degree with the frame of the user to be tested as the frame of the object to be tested.

5. The method according to claim 1, wherein when the real-time image output comprises the image of the object to be tested and a plurality of user images, step (B) comprises sub-steps of:
(B1) performing the artificial intelligence recognition on the real-time image output to obtain the frame of the object to be tested and a plurality of user frames that respectively cover the user images;
(B2) determining whether the user frames contain a user frame having an area greater than an area of the frame of the object to be tested;
(B3) when the judgement result of sub-step (B2) is yes, using each user frame of the user frames that has an area greater than the area of the frame of the object to be tested as a target user frame; and
(B4) using the target user frame having a largest overlapping degree with the frame of the object to be tested as the frame of the user to be tested.

6. The method according to claim 1, wherein in step (C), within a predetermined detection time,
when a presence time of an accumulate presence of the frame of the user to be tested is greater than or equal to a first predetermined time, a change in the area of the frame of the user to be tested is smaller than a predetermined area change value, and a change in a coordinate position of the frame of the user to be tested is smaller than a predetermined position change value, the frame of the user to be tested is in the position stable state, and
when a presence time of an accumulated presence of the frame of the object to be tested is greater than or equal to a second predetermined time, the area of the frame of the object to be tested at least partially overlaps the area of the frame of the user to be tested, and an accumulated overlapping time of the area at least partially overlapping is greater than or equal to a third predetermined time, the frame of the object to be tested is in the stable presence state.

7. The method according to claim 1, wherein in step (D), the detecting of the movement of the object to be tested detects a movement trajectory of a center point of the frame of the object to be tested, and comprises detecting a relative change in an area size of the frame of the object to be tested and using the movement trajectory or the area change in the frame of the object to be tested as the movement change.

8. The method according to claim 1, wherein the electronic device comprises a predetermined operation function database, which stores a plurality of predetermined movement changes and a plurality of respective corresponding predetermined operation instructions, wherein step (D) comprises sub-steps of:
(D1) determining, according to the real-time image output, whether a center point of the frame of the object to be tested is moved outside an initial positioning frame, wherein an area of the initial positioning frame is smaller than an area of the frame of the object to be tested, and a center point of the initial positioning frame is same as the center point of the frame of the object to be tested that has not yet moved;
(D2) when the judgement result of sub-step (D1) is yes, determining, according to the real-time image output, whether the center point of the frame of the object to be tested having been moved is moved back inside the initial positioning frame within a predetermined movement time;
(D3) when the judgement result of sub-step (D2) is yes, forming, according to a position of the center point of the initial positioning frame, and a position of the center point of each of the frame of the object to be tested that has been moved when the frame the object to be tested is moved outside the initial positioning frame and moved back inside the initial positioning frame, a movement trajectory as the movement change; and
(D4) comparing the movement change with the predetermined movement changes in the predetermined operation function database to obtain the corresponding predetermined operation instruction as the operation instruction.

9. The method according to claim 8, wherein step (D) further comprises a sub-step of:
(D5) when the judgment result of the sub-step (D2) is negative, generating a warning instruction indicating a gesture detection error or a detection failure, and playing a warning response according to the warning instruction, such that the object to be tested is again moved when the user to be tested hears the warning response.

10. The method according to claim 1, wherein the operation instruction instructs the electronic device to activate playing music, play a next music track or play a previous music track, stop playing music, or pause playing music.

11. A non-transitory computer-readable storage medium, storing a plurality of program codes, wherein an electronic device, after reading the program codes, is enabled to perform the method of claim 1.

12. An electronic device applying artificial intelligence to detect gestures, comprising:
a camera unit, for taking a photograph of a region to be detected to obtain a real-time image output, the real-time image output at least comprising an image of an object to be tested corresponding to an object to be tested, and an image of a user to be tested corresponding to a user to be tested;
a storage unit, storing a plurality of program codes;
a smart processing unit, electrically connected to the camera unit to receive the real-time image output, and electrically connected to the storage unit to read the program codes and perform a plurality of operations including:
performing artificial intelligence recognition on the real-time image output to obtain a frame of the object to be tested that covers the image of the object to be tested, and a frame of the user to be tested that covers the image of the user to be tested;
determining whether the frame of the user to be tested is in a position stable state, and determining whether the frame of the object to be tested is in a stable presence state; and
when the frame of the user to be tested is in a position stable state and the frame of the object to be tested is in a stable presence state, recognizing by the artificial intelligence that the user to be tested holds the object to be tested, and recognizing by the artificial intelligence the real-time image output and detecting a movement of the object to be tested, so as to generate a movement change and trigger and generate an operation instruction corresponding to the movement change; and
a playback unit, electrically connected to the smart processing unit to receive the operation instruction, and performing a corresponding media processing operation according to the operation instruction, wherein the media processing operation is selected from an audio information processing and/or an image information processing.

13. The electronic device according to claim 12, wherein when the real-time image output comprises a plurality of object images and the image of the user to be tested, the smart processing unit performs the artificial intelligence recognition on the real-time image output to obtain a plurality of object frames that respectively cover the object images, and the frame of the user to be tested; the smart processing unit determines whether the object frames contain an object frame having an area smaller than an area of the frame of the user to be tested, and when the judgement result is yes, uses each object frame of the object frames that has an area smaller than the area of the frame of the user to be tested as a target object frame; and the smart processing unit uses the target object frame having a largest overlapping degree with the frame of the user to be tested as the frame of the object to be tested.

14. The electronic device according to claim 12, wherein when the real-time image output comprises the image of the object to be tested and a plurality of user images, the smart processing unit performs the artificial intelligence recognition on the real-time image output to obtain the frame of the object to be tested and a plurality of user frames that respectively cover the user images; the smart processing unit determines whether the user frames contain a user frame having an area greater than an area of the frame of the object to be tested, and when the judgement result is yes, uses each user frame of the user frames that has an area greater than the area of the frame of the object to be tested as a target user frame; and the smart processing unit uses the target user frame having a largest overlapping degree with the frame of the object to be tested as the frame of the user to be tested.

15. The electronic device according to claim 12, wherein within a predetermined detection time, when a presence time of an accumulated presence of the frame of the user to be tested is greater than or equal to a first predetermined time, a change in the area of the frame of the user to be tested is smaller than a predetermined area change value, and a change in coordinate position of the frame of the user to be tested is smaller than a predetermined position change value, the frame of the user to be tested is in the position stable state; when a presence time of an accumulated presence of the frame of the object to be tested is greater than or equal to a second predetermined time, the area of the frame of the object to be tested at least partially overlaps the area of the frame of the user to be tested, and an accumulated overlapping time of the area at least partially overlapping is greater than or equal to a third predetermined time, the frame of the object to be tested is in the stable presence state.

16. The electronic device according to claim 12, further comprising:
a predetermined operation function database, which stores a plurality of predetermined movement changes and a plurality of respective corresponding predetermined operation instructions;
wherein, the smart processing unit determines, according to the real-time image output, whether a center point of the frame of the object to be tested is moved outside an initial positioning frame; when the judgement result is yes, the smart processing unit determines, according to the real-time image output, whether the center point of the frame of the object to be tested that has been moved is moved back inside the initial positioning frame within a predetermined movement time; when the judgement result is yes, the smart processing unit forms, according to a position of the center point of the initial positioning frame, and a position of the center point of each of the frame of the object to be tested that has been moved when the frame of the object to be tested is moved outside the initial positioning frame and moved back inside the initial positioning frame, a movement trajectory as the movement change, and compares the movement change with the predetermined movement changes in the predetermined operation function database to obtain the corresponding predetermined operation instruction as the operation instruction, wherein an area of the initial positioning frame is smaller than the area of the frame of the object to be tested, and the center point of the initial positioning frame is same as the center point of the frame of the object to be tested that has not yet moved.

17. A terminal device, communicatively connected to the electronic device according to claim 16 and mounted with an application, the terminal device becoming communicatively connected to the electronic device by executing the application, wherein the terminal device provides a user interface while executing the application, and a user can set the predetermined operation function database and/or perform the media processing operation via the user interface.
